(19) United States
(12) Patent Application Publication
(10) Pub. No.: US 2025/0158385 A1
(43) Pub. Date: May 15, 2025

(54) Power Distributor, Power Distribution System and Vehicle Therewith

(71) Applicant: Bayerische Motoren Werke Aktiengesellschaft, Muenchen (DE)

(72) Inventors: Florian BIERWIRTH, Steinhoering (DE); Joachim FROESCHL, Herrsching (DE)

(21) Appl. No.: 18/833,500

(22) PCT Filed: Jan. 27, 2023
(86) PCT No.: PCT/EP2023/052020

§ 371 Date: Jul. 26, 2024

(30) Foreign Application Priority Data
Feb. 3, 2022 (DE) 10 2022 102 570.5

(51) Int. Cl. H02H 3/10; H02H 1/00; H02H 5/04

(52) U.S. Cl. CPC H02H 3/10; H02H 1/0007; H02H 5/047

(57) ABSTRACT

A power distributor includes a supply input connected to a plurality of component outputs via respective component power branches, wherein each of the component power branches comprises at least one component fuse element, and at least one bypass power path which leads from a supply input to at least two of the component outputs and has the at least one electronic bypass fuse.

### BACKGROUND AND SUMMARY

The invention relates to a power distributor comprising a supply input which is electrically connected to component outputs via respective component power branches, wherein each of the component power branches comprises at least one fuse element. The invention also relates to a power distribution system having a power distributor of this type and a trip logic circuit. The invention further relates to a vehicle comprising at least one power distribution system of this type. The invention moreover relates to a method for operating a power distribution system. In particular, the invention is advantageously applicable to vehicles having a partially- or fully-automated driving function.

The reliability and availability of electrical connections is now assuming an increasingly high degree of significance, particularly in the context of partially- or highly-automated driving. In this regard, electronic fuses (also known as “eFuses” or “smart fuses”) are increasingly employed in a vehicle as protective components for power supply paths. An electronic fuse comprises one or more semiconductor components, which include a disconnector (e.g. a transistor, for example a MOSFET) for the optional switching of the electronic fuse to a non-conducting or conducting state. An electronic fuse can also comprise one or more voltage measuring devices and/or at least one current measuring device. Voltage and/or current measuring devices can also be configured in the form of one or more semiconductor components.

The at least one voltage measuring device can measure the voltage on the current path which is routed through the electronic fuse, e.g. up-circuit and/or down-circuit of the electronic disconnector. The current measuring device measures the current flowing through the electronic fuse. Voltage and/or current measurement values can be transmitted to entities which are external to the electronic fuse, e.g. to an energy management system, which can then employ these measured values for any arbitrary purposes. In particular, voltage and/or current measuring devices can also be employed for monitoring the voltage response and/or current response on the electronic fuse, wherein the disconnector, in the event of the detection of a response which is potentially harmful to vehicle components which are to be protected, or to other components in the system, can be actuated such that it assumes a non-conducting or open state. Via voltage and/or current measuring devices, moreover, a functional capability of the electronic disconnector can be verified.

Monitoring and verification are executed by a data processing device which can be described as a “trip logic circuit”, and which is connected both to the voltage and/or current measuring devices and to a control terminal of the electronic disconnector (e.g. to a gate terminal) with a signal transmission capability. The trip logic circuit can thus monitor measured values, and can actuate the disconnector in an appropriate manner. The trip logic circuit can be integrated in the electronic fuse—for example by hardware—or can comprise an external unit.

However, in response to degradation-related phenomena or measuring errors in the semiconductor components thereof, electronic fuses can function defectively, or can even fail. Accordingly, progressive degradation is generally associated with an increasing ohmic resistance in the current path of the electronic fuse which, in the event of a flow of current, is associated with a rise in temperature (generated by waste heat associated with contact resistance). This rise in temperature can result in a permanent interruption of the electronic fuse, or can even generate a thermal event.

DE 10 2019 120 567 A1 discloses an on-board electric power network for a motor vehicle, comprising a power distributor and a plurality of first conductors which are designed to connect a corresponding plurality of electrical components to the power distributor. The on-board network further comprises a plurality of semiconductor-based first switching elements for the corresponding plurality of first conductors, wherein a specific first switching element of a specific first conductor is configured to interrupt the specific first conductor. The on-board network further comprises a second conductor, which is configured to connect the power distributor to the on-board network, and a limiter unit, which is designed to limit or suppress a second current on the second conductor. The on-board network further comprises a control unit, which is designed to determine the absence of the opening of the specific first switching element, notwithstanding an overshoot of a first current threshold value by a first current flowing in the specific first switching element and, in response thereto, to initiate the limitation or suppression by the limiter unit of the second current on the second conductor.

DE 10 2020 106 210 A1 discloses an energy supply system for a motor vehicle, having at least one energy source, having a power supply rail into which electrical energy can be injected by the energy source, having at least two power distributors which are electrically connected to the power supply rail and which can be supplied with energy from the power supply rail, and having a control device, by which at least one measured value is receivable from the energy supply system, and by which the power distributors are controllable in accordance with the at least one measured value, wherein the power distributors are directly electrically connected to the power supply rail and each comprise a plurality of parallel-connected power distribution paths, each comprising at least one fuse element, via which at least one motor vehicle component can be supplied with electrical energy.

An object of the present invention is the at least partial resolution of the disadvantages of the prior art and, in particular, the provision of a cost-effective option by which the availability of an electrical energy supply to a plurality of, in particular, safety-related current paths, or current paths with a high availability rating, is ensured in a particularly reliable manner.

This object is fulfilled by the features of the present disclosure. Preferred embodiments, in particular, can also be identified from the present disclosure.

This object is fulfilled by a power distributor, comprising: a first electric terminal (described hereinafter, without loss of generality, as a “supply input”) which, by respective power branches or current paths (described hereinafter, without loss of generality, as “component power branches”), is electrically connected to a plurality of second electric terminals (described hereinafter, without loss of generality, as “component outputs”), wherein each of the component power branches comprises at least one fuse element (described hereinafter, without loss of generality, as a “component fuse element”), and at least one current path (described hereinafter, without loss of generality, as a “bypass current path”), which is routed from a supply input to at least two of the component outputs, and which comprises at least one electronic fuse (described hereinafter, without loss of generality, as an “electronic bypass fuse”).

Accordingly, in this power distributor, a plurality or, optionally, even the totality of component power branches are protected by a bypass current path which is connected in parallel thereto. In the event of the occurrence of a malfunction or a fault on one of the component power branches (e.g. the assumption of a high resistance by an electronic fuse, the spurious tripping thereof, the degradation thereof, etc.), the bypass current path can intervene for the supply of at least one electrical component which is arranged down-circuit of the component power branch. As not every component power branch comprises a dedicated bypass current path, but a common bypass current path is shared by a plurality of component power branches, components, and thus costs and structural space, can be economized.

A power distributor is particularly to be understood as an arrangement in which an electrical conductor—which is typically connectable to an electrical energy source such as a voltage generator, a DC voltage converter or a battery—is connected to a supply input or forms the supply input, and then branches into a plurality of component power branches or current paths, which are routed to the respective component outputs or which terminate at the respective component outputs. In each case, component power branches, via the component outputs thereof, are particularly configured for the connection of at least one electrical component, which is to be supplied with electrical energy, particularly an electric current, by the electrical energy source.

In a further development, the power distributor is configured as a standalone assembly which, for example, comprises a dedicated housing. In a further development, the power distributor corresponds to an above-mentioned arrangement or topology of power branches and fuse elements, and can comprise part of a superordinate component or a superordinate assembly.

A fuse element is particularly to be understood as an electrical element which protects the component power branch or down-circuit electrical components, wherein it switches the component power branch to a non-conducting state in response to the occurrence of a safeguarding event (e.g. the occurrence of an overcurrent, an undervoltage, etc.). The fuse element can be configured, for example, in the form of an electronic fuse (eFuse or smart fuse), or in the form of a mechanical fuse, such as a fusible link.

In each case, at least one fuse element is thus present in each component power branch. The at least one fuse element can be identical for at least two and, in particular, for the totality of component power branches. However, the at least one fuse element can also be different in at least two component power branches, particularly with respect to the number, type (electronic fuse, fusible link, etc.) and/or the topology thereof (parallel-connected, series-connected, etc.).

In particular, the at least one electronic bypass fuse comprises exactly one electronic fuse (eFuse) or assumes a topology comprised of a plurality of mutually interconnected electronic fuses. In particular, the supply input of the bypass current path is connected to the at least one electronic bypass fuse. According to a further development, the bypass current path is branched from its at least one electronic bypass fuse to the at least two component outputs. In particular, this signifies that the at least one electronic bypass fuse is electrically arranged in series with each of the component outputs which are electrically connected thereto.

As the bypass current path comprises at least one electronic fuse, the bypass current path can be maintained open, provided that the fuse elements of the component power branches which are connected thereto via the component outputs are fault-free. In the event of the occurrence of a fault or failure of fuse elements in at least one of the component power branches, the at least one electronic fuse of the bypass current path can be deliberately actuated, such that electrical components which are arranged down-circuit of the component power branch concerned can continue to be supplied with power via the bypass. The bypass current path thus “intervenes” in place of the defective or failed component power branch. For the remaining fault- or failure-free component power branches, power availability at the component outputs thereof is given by the superimposition of power availability via the respective component power branch and power availability via the bypass current path.

According to one configuration, the at least one electronic bypass fuse comprises exactly one electronic fuse (“bypass” eFuse). This configuration can advantageously be implemented in a particularly compact and cost-effective manner.

According to one configuration, the at least one electronic bypass fuse comprises at least two electronic fuses. An advantage is thus achieved in that-depending upon the topology of these electronic fuses-a particularly reliable opening, closing, sustained opening or sustained closing of the bypass current path is achieved.

According to a further development, the at least one electronic bypass fuse comprises exactly two electronic fuses. As a result, a particularly reliable opening or closing of the bypass current path can be achieved with a limited number of electronic fuses.

According to one configuration, the at least two—and, in particular, the only two-electronic (bypass) fuses are electrically arranged in series in the bypass current path (“horizontal redundancy”). As a result, advantageously, a particularly reliable opening/interruption of the bypass current path is achieved with a limited number of electronic fuses, e.g. even in the event that one of the two electronic fuses is defectively and permanently closed or switched to a conducting state.

According to a further development, the at least two—and, in particular, the only two—electronic (bypass) fuses are electrically arranged in parallel in the bypass current path (“vertical redundancy”). As a result, a particularly reliable closing/on-state of the bypass current path is achieved with a limited number of electronic fuses, e.g. even in the event that one of the two electronic fuses is defectively and permanently open or switched to a non-conducting state. It is particularly advantageous that diodes are present in the two electrically parallel-connected bypass current paths. These can be standalone components or, alternatively, diodes can be functionally integrated in electronic fuses, for example if the latter incorporate a switch in the form of a MOSFET. According to a further development, the diodes are Schottky diodes.

According to a further development, the at least one electronic bypass fuse comprises four electronic fuses, which are configured in an electrically serial-parallel arrangement in the bypass current path, i.e. in an arrangement having two parallel-connected current paths, in each of which two electronic fuses are arranged in series. As a result, advantageously, a particularly reliable connection and interruption of the bypass current path is achieved, whilst still employing a comparatively limited number of electronic fuses. This further development is still more compact and more cost-effective, in comparison with a corresponding arrangement in each component power branch.

According to one configuration, the at least one component fuse element of at least one component power branch and, in particular, of all the component power branches, comprises at least one electronic fuse. As a result, it is advantageously achieved that the component power branch can be optionally switched to a conducting or non-conducting state in a particularly flexible manner.

According to one configuration, the at least one component fuse element of at least one component power branch and, in particular, of all the component power branches, comprises at least one fusible link. Accordingly, a particularly cost-effective and robust overcurrent protection of the associated component power branch, or of electrical components connected thereto which are to be protected, can be achieved.

According to one configuration, the at least one component fuse element of at least one component power branch and, in particular, of all the component power branches comprises a plurality of and, in particular, two series-connected component fuse elements. This permits a particularly reliable disablement or interruption of the component power branch concerned. The plurality of series-connected component fuse elements can comprise, for example, at least two electronic fuses, or at least one electronic fuse and one fusible link.

According to a further development, the current-carrying capacity of the bypass current path is of at least equal magnitude to the sum of the maximum rated currents of safety-related loads which are connected to the component power branches (and, at the component outputs thereof, to the bypass current path).

According to one configuration, the current-carrying capacity of the at least one bypass current path (and, in the event of a plurality of bypass current paths, of each individual bypass current path or, alternatively, of the bypass current paths in combination) is of at equal magnitude to the maximum rated current and, in particular, to the maximum continuous rated current of the largest load which is connected to the component power branches (and, at the component outputs thereof, to the bypass current path), i.e. the load having the highest maximum rated current.

According to a further development, the current-carrying capacity of the bypass current path is of at least equal magnitude to the sum of the current-carrying capacities of the component power branches (which are connected, at their component outputs, to the bypass current path). An advantage is thus achieved, in that the bypass current path can simultaneously bridge all these component power branches in a secure manner.

However, it is not necessary for the current-carrying capacity of the bypass current path to be of equal magnitude to the maximum continuous rated current of the largest load of the totality of loads, or to the sum of the current-carrying capacities of the component power branches. In principle, the current-carrying capacity of the bypass current path can also be configured with a lower rating, for example on the grounds of a typically short error duration. This advantageously permits a smaller dimensioning, with associated cost benefits, for the electric current path(s) and the electronic fuse(s) of the bypass current path.

Additionally, a particularly cost-effective bypass current path can be embodied wherein, in the event of a fault, and thus during the employment of the bypass current path, electrical components which are connected to the component power branches are operated in a state of degradation which is still acceptable. This state of degradation is such that the respective component current, and thus the total current of the affected component power branches, is restricted to the lowest possible level.

According to one configuration, exactly one bypass current path is provided. A particularly simple and cost-effective design is permitted accordingly.

According to a further development, the bypass current path is electrically connected to all the component outputs of the power distributor. An advantage is thus achieved, in that the bypass current path can be employed as a backup power supply facility for all the component outputs. According to a further development, the bypass current path is electrically connected to only a proportion or to only a subset of the component outputs of the power distributor. This advantageously permits the employment of a cost-effective bypass current path having a low current-carrying capacity. Those component power branches, the component outputs of which are not connected to the bypass current path are not redundantly protected by the bypass current path.

According to one configuration, a plurality of bypass current paths are provided. This provides an advantage, in that a power distributor having a multiplicity of component power branches can be operated in a particularly reliable manner.

According to a further development, at least two and, in particular, all the bypass current paths are connected to different component outputs. This provides an advantage, in that a multiplicity and, in particular, all the component power branches can be redundantly protected by cost-effective bypass current paths having a comparatively low current-carrying capacity.

According to a further development, at least two and, in particular, all the bypass current paths are connected to at least two and, in particular, to all the component outputs. An advantage is thus achieved, in that the bypass current paths themselves can be configured with a redundant design, thus further enhancing the operational reliability of the power distributor.

According to one configuration, the supply input (also describable as the “component supply input”) which is connected to the component power branches corresponds to the supply input of the at least one bypass current path (also describable as the “bypass supply input”). The bypass current path thus originates from the same supply input from which the component power branches also originate, and is thus connected to the same electrical energy source as the latter. The at least one bypass current path is arranged electrically in parallel with the component power branches. This configuration can be implemented in a particularly simple manner.

According to one configuration, the (component) supply input which is connected to the component power branches is a supply input which differs from the (bypass) supply input of the at least one bypass current path. The power supply of the at least one bypass current path can thus be executed by a second and independent electrical energy source. An advantage is thus achieved, in that malfunctions or faults which are associated with the current path to the component power branches are suppressed by the activation of the bypass. For example, in the event of the short-circuiting or failure of the electrical energy source which is connected to the component supply input, the supply of energy to components which are to be protected can be switched over to a different and, in particular, to a more high-capacity energy source, and any voltage dip associated with the short-circuit can thus be maintained within a controlled range. Moreover-particularly in the event of a rising number of safety-related loads, e.g. in the context of partially- or highly-automated driving-costs and structural space can be economized.

The object is further fulfilled by a power distribution system, comprising a power distributor according to one of the preceding claims, and a trip logic circuit, which is designed to at least switch the at least one electronic bypass fuse. The power distribution system can be configured in an analogous manner to the above-mentioned power distributor, and comprises the same advantages.

In particular, a trip logic circuit can be understood as a data processing device which evaluates measured or estimated values of physical variables (e.g. voltage, current, temperature, etc., in the form of discrete values and/or in the form of curves), and/or variables which are derived therefrom (e.g. differentials, extreme values, gradients, integrals, etc.) and, on the basis of this evaluation, arrives at a decision with respect to the circuit state (conducting/non-conducting or open/closed) of the switch of at least the electronic bypass fuse, and actuates the latter for the assumption of the desired circuit state.

The trip logic circuit can comprise a data processing device, which is designed to execute its function by a corresponding software. However, the trip logic circuit can also be provided in the form of hardware, or in the form of a hard-wired circuit.

According to a further development, the trip logic circuit is integrated in the power distributor.

According to a further development, the trip logic circuit is a component which is distinct from the power distributor and, in particular, is a vehicle component, and is thus an “external” entity. This entity can be a standalone component, or can be functionally integrated in a component which is employed for other purposes, such as an energy management system, an on-board computer, etc.

In particular, the trip logic circuit can be designed to actuate the at least one electronic bypass fuse on the basis of a state-of-health of at least one component fuse element, particularly in the event that a malfunction, a fault or a tripping of at least one component fuse element has been detected. Malfunctions and faults of an electronic fuse or eFuse can include, for example, the degradation thereof, a high resistance in the conducting state, spurious tripping, a current or voltage measuring error, etc. Tripping of a fusible link can comprise, for example, the fusion or interruption of the fusible element thereof.

In order to establish the state-of-health of an electronic fuse, for example, signals or measured values from the internal voltage measuring device(s) thereof and/or from the internal current measuring device thereof can be employed, where available. In particular, by the correlation of measured values from different measuring devices of an electronic fuse, advantageously, faults and malfunctions can be identified in a particularly reliable manner and, optionally, can even be anticipated, and a particularly operationally secure and intelligent response to such events can be implemented. To this end, the trip logic circuit can be connected to at least one of these measuring devices with a signal transmission capability, and can thus receive measured values from the at least one measuring device in an analog or digital form.

According to a further development, the power distributor is designed to determine at least one temperature on at least one of the current paths thereof (including, optionally, any electronic fuses which are present therein). This advantageously permits, for example, the detection of any abnormal temperature increases which are generated in a component power branch in response to defects or in response to operation in an extreme range.

The design of the power distributor to determine at least one temperature on at least one of the current paths thereof (including, optionally, any electronic fuses which are present therein) includes the design of the power distributor to determine at least one temperature between the supply terminal and the branch-off points to the component power branches and/or in one, a plurality or all the component power branches.

According to a further development, the power distributor is designed to measure at least one temperature on the current path thereof. To this end, the power distributor can be equipped with at least one temperature measuring device.

According to a further development, the at least one temperature measuring device is a dedicated temperature sensor.

According to a further development, the at least one temperature measuring device is an electronic fuse of the component power branches. To this end, the electronic fuse is designed to determine and, in particular, to measure a temperature, in particular a characteristic temperature. To this end, according to a further development, the at least one electronic fuse can be equipped with a temperature measuring device, in particular with a temperature sensor.

According to a further development, the vehicle, in particular the power distributor thereof, is designed to estimate at least one temperature on at least one of the current paths thereof, for example by a model-based calculation and, in particular, on the basis of measured values other than temperature.

In particular, the trip logic circuit is additionally designed to actuate the at least one electronic bypass fuse on the basis of temperature values (captured temperature measurement values, estimated temperature values, etc.). An advantage is thus achieved, in that the bypass current path can additionally be employed for the thermal stress-relief of component power branches. In the event that, for example, on at least one of the electronic fuses of at least one component power branch, a raised temperature is detected, the bypass current branch can be switched to a conducting state, such that the current flowing through the at least one component power branch, or at least a proportion thereof, is diverted via the bypass current path, thus contributing to a temperature reduction on the at least one component power branch, or preventing, or at least delaying, the overheating thereof.

In general, the at least one electronic fuse of the component power branches can be designed to measure a voltage, a voltage differential, a current and/or a temperature, in particular a characteristic temperature. The trip logic circuit, for the reception of measured values from the at least one electronic fuse, can be connected to the latter by data technology (e.g. in an internal arrangement, by corresponding internal signal lines which are routed to the corresponding measuring points or, in an internal arrangement, by signal or data lines, e.g. a data bus), and is designed to receive corresponding measured values from the at least one electronic fuse and to actuate the at least one electronic bypass fuse on the basis of measured values thus received and/or on the basis of values-including model-based values-which are derived therefrom. This arrangement can be applied, in an analogous manner, to further measuring devices of the power distributor.

The object is further fulfilled by a vehicle comprising at least one power distributor of the above-mentioned type and/or at least one power distribution system of the above-mentioned type. The vehicle can be configured in an analogous manner to the power distributor and the power distribution system, and vice versa, and the same advantages proceed therefrom.

According to a further development, the vehicle comprises a plurality of power distributors, the electronic bypass fuses of which are actuatable by a common trip logic circuit.

The vehicle can be a vehicle having a combustion engine, a hybrid vehicle or a fully electrically-powered vehicle. The vehicle can be a land vehicle (such as a passenger car, a goods vehicle, a motorcycle, a bus, etc.) a water craft, a spacecraft (such as a Mars rover or a rocket), or an aircraft (such as an airplane, a helicopter, etc.).

In particular, the vehicle is a partially- or fully-autonomously driven vehicle, for which the power distributor and the power distribution system can assume a particular utility, on the grounds of the increased significance of the failsafe capability of electrical components.

The object is moreover fulfilled by a method, in particular for operating a power distribution system of the above-mentioned type, wherein a fault, a malfunction and/or a tripping of at least one component fuse element is detected and, on the basis thereof, at least one electronic bypass fuse is actuated. In particular, the at least one electronic bypass fuse can be actuated such that a switchover of the bypass current path is executed from a non-conducting to a conducting or transmitting state thereof.

The method can be configured in an analogous manner to the vehicle, the power distributor and the power distribution system, and vice versa, and the same advantages proceed therefrom.

The above-mentioned properties, features and advantages of the present invention, and the manner in which these are achieved, are more clearly and comprehensibly presented in conjunction with the following schematic description of one exemplary embodiment, which is described in greater detail with reference to the drawings.

### BRIEF DESCRIPTION OF THE DRAWINGS

FIG. 1 shows a sketch of a power distribution system of a vehicle, having a power distributor according to a first exemplary embodiment;

FIG. 2 shows a sketch of one potential configuration of the at least one electronic bypass fuse of the power distribution system according to FIG. 1;

FIG. 3 shows a sketch of a further potential configuration of the at least one electronic bypass fuse of the power distribution system according to FIG. 1;

FIG. 4 shows a sketch of one potential configuration of the at least one fuse element of a component power branch of the power distribution system according to FIG. 1;

FIG. 5 shows a sketch of one potential configuration of the at least one fuse element of a component power branch of the power distribution system according to FIG. 1; and

FIG. 6 shows a sketch of a power distributor according to a second exemplary embodiment; and

FIG. 7 shows a sketch of a power distributor according to a third exemplary embodiment.

### DETAILED DESCRIPTION OF THE DRAWINGS

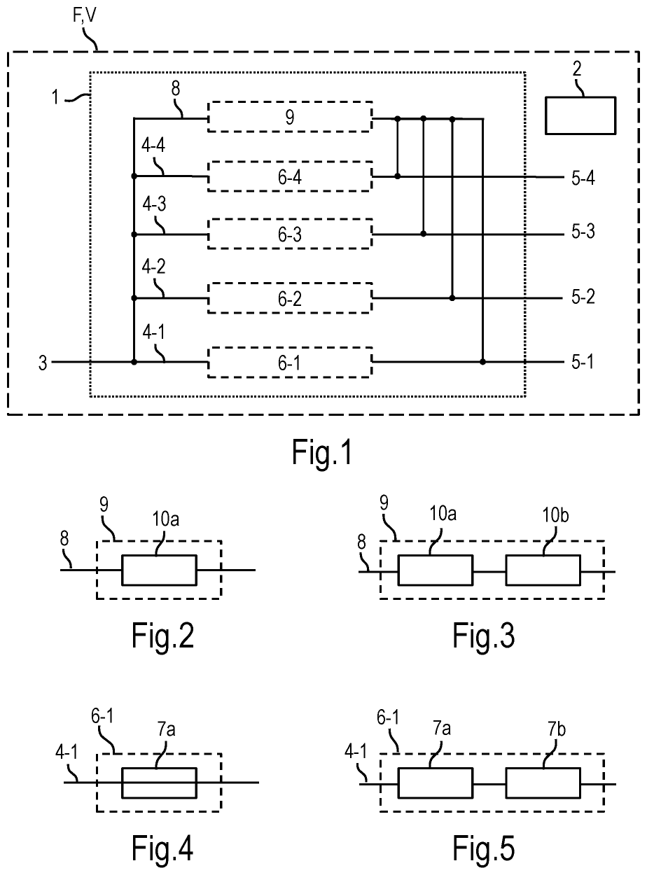

FIG. 1 shows a sketch of a power distribution system 1, 2 of an on-board power supply network V of a vehicle F, having a power distributor 1 and a trip logic circuit 2 which, for exemplary purposes only, is located externally to the power distributor 1.

The power distributor 1 comprises a supply input 3, which is connected e.g. to an (unrepresented) electrical energy source and which, via corresponding (and, in the present exemplary case) four component power branches 4-1 to 4-4, branches off to a plurality of component outputs 5-1 to 5-4. In each case, one or more (unrepresented) loads can be connected to the component outputs 5-1 to 5-4. Each of the component power branches 4-1 to 4-4 comprises a fuse assembly 6-1 to 6-4, each comprising at least one component fuse element 7a, 7b (see FIG. 4 and FIG. 5).

The power distributor 1 further comprises a bypass current path 8, which comprises a fuse assembly 9 having at least one electronic bypass fuse or eFuse 10a, 10b (see FIG. 2 and FIG. 3). The bypass current path 8 is routed from the supply input 3 to the fuse assembly 9 and, down-circuit thereof, branches off to each of the component outputs 5-1 to 5-4. The bypass current path 8 is thus arranged electrically in parallel with each of the component power branches 4-1 to 4-4.

The exemplary design of the bypass current path 8 is such that the current-carrying capacity thereof is of at least equal magnitude to the maximum rated current of the largest load which is connected to the component power branches 4-1 to 4-4 and, in particular, is of at least equal magnitude to the sum of the maximum currents of loads which are connected to the component power branches 4-1 to 4-4.

The trip logic circuit 2 is designed, in response to a fault, malfunction and/or the tripping of at least one of the component fuse elements 7a, 7b, to actuate the at least one electronic bypass fuse 10a, 10b, such that the latter assumes or maintains a conducting state. For example, a switchover can be executed on the at least one electronic bypass fuse 10a, 10b from a normally non-conducting state to a conducting state.

FIG. 2 shows a sketch of one potential configuration of a fuse assembly 9, wherein the latter comprises exactly one electronic fuse 10a.

FIG. 3 shows a sketch of a further potential configuration of the fuse assembly 9, having two electronic fuses 10a, 10b which are electrically interconnected in series.

FIG. 4 shows a sketch of one potential configuration of the fuse assembly 6-1 of the component power branch 4-1 wherein the latter comprises exactly one fuse element 7a, for example an electronic fuse (eFuse) or a fusible link.

FIG. 5 shows a sketch of one potential configuration of the fuse assembly 6-1, having two fuse elements 7a, 7b which are electrically interconnected in series, for example two electronic fuses, or one electronic fuse and one fusible link.

At least a number of the fuse assemblies 6-2, 6-3 and 6-4 can be identically configured to the fuse assembly 6-1, or can be differently configured.

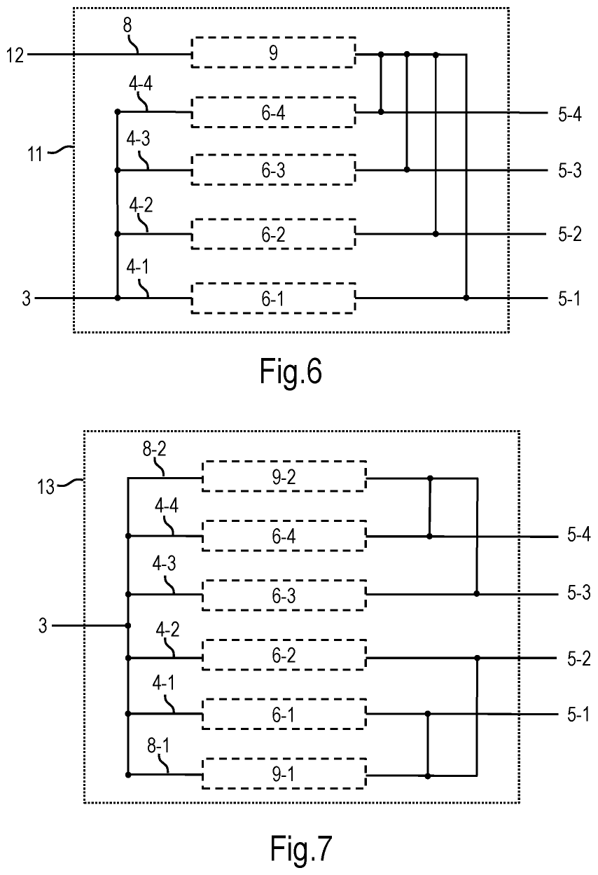

FIG. 6 shows a sketch of a power distributor 11. The power distributor 11 assumes a similar basic design to the power distributor 1, wherein, however, the component supply input 3 which is connected to the component power branches 4-1 to 4-4 is a supply input which differs from the bypass supply input 12 of the at least one bypass current path 8.

FIG. 7 shows a sketch of a power distributor 13. The power distributor 11 assumes a similar basic design to the power distributor 1 but, in this case, now comprises two bypass current paths 8-1 and 8-2 having a respective fuse assembly 9-1 or 9-2, both of which are arranged on the (component) supply input 3. The fuse assemblies 9-1, 9-2 can be configured in an analogous manner to the fuse assembly 9, and can be identical or different. In this case, the fuse assemblies 9-1, 9-2 are connected to different component outputs 5-1 to 5-4 such that, in an exemplary manner, the bypass current path 8-1 is arranged in parallel to the component power branches 4-1 and 4-2, and the bypass current path 8-2 is arranged in parallel to the component power branches 4-3 and 4-4.

The electronic fuse(s) 10a, 10b of the at least one bypass current path 8 or 8-1, 8-2 of the power distributor 1, 11 or 13 can be actuated by the trip logic circuit 2 such that, in the event of the regulation operation of the component fuse elements 7a, 7b (and thus, e.g., in the absence of the occurrence of any malfunction or fault, the burn-out of a fusible link, etc.), the trip logic circuit 2 actuates the electronic fuse(s) 10a, 10b such that the latter are electrically non-conductive, and the at least one bypass current path 8 or 8-1, 8-2 thus carries no current, or is not active.

However, in the event of the non-regulation operation of the component fuse elements 7a, 7b, the electronic fuse(s) 10a, 10b of the at least one bypass current path 8 or 8-1, 8-2 can, for example, be actuated by the trip logic circuit 2 such that the latter assume an electrically conductive state, and the at least one bypass current path 8 or 8-1, 8-2 thus carries a current, or is active.

Naturally, the present invention is not limited to the exemplary embodiments disclosed.

In principle the features of the exemplary embodiments disclosed can thus be interchanged and/or combined in an arbitrary manner. For example, on the basis of FIG. 3, more than two bypass current paths can also be provided. Moreover, in the event of the provision of a plurality of bypass current paths 8-1 and 8-2, the latter can also be connected to at least one of the same component outputs 5-1 to 5-4. Moreover, on the basis of FIG. 3, the bypass current paths 8-1 and 8-2, in an analogous manner to FIG. 2, can be connected to a bypass supply input 12 which differs from the component supply input 3. Moreover, different bypass current paths 8-1, 8-2 can also be connected to separate bypass supply inputs, or one bypass current path can be connected to the component supply input 3, whereas another bypass current path can be connected to a bypass supply input, etc.

In general, “a”, “an”, etc. can be understood to signify a singular or a plural, particularly in the sense of “at least one”, “one or more”, etc., provided that this is not expressly excluded, e.g. by the employment of the term “exactly one”, etc.

Additionally, a numerical indication can signify exactly the number indicated, or can include a customary tolerance range, provided that this is not explicitly excluded.

### LIST OF REFERENCE SYMBOLS

1 Power distributor
2 Trip logic circuit
3 Supply input
4-1 Component power branch
4-2 Component power branch
4-3 Component power branch
4-4 Component power branch
5-1 Component output
5-2 Component output
5-3 Component output
5-4 Component output
6-1 Fuse assembly
6-2 Fuse assembly
6-3 Fuse assembly
6-4 Fuse assembly
7a Component fuse element
7b Component fuse element
8 Bypass current path
8-1 Bypass current path
8-2 Bypass current path
9 Fuse assembly
10a Electronic bypass fuse
10b Electronic bypass fuse
11 Power distributor
12 Bypass supply input
13 Power distributor
F Vehicle
V On-board power supply network

1.-15. (canceled)

16. A power distributor comprising:
a supply input electrically connected to a plurality of component outputs via respective component power branches, wherein each of the component power branches comprises at least one component fuse element; and
at least one bypass current path that is routed from a supply input to at least two of the component outputs, and which comprises at least one electronic bypass fuse.

17. The power distributor according to claim 16, wherein the at least one electronic bypass fuse comprises exactly one electronic fuse.

18. The power distributor according to claim 16, wherein the at least one electronic bypass fuse comprises at least two electronic fuses.

19. The power distributor according to claim 18, wherein at least two electronic bypass fuses are electrically arranged in series in the at least one bypass current path.

20. The power distributor according to claim 16, wherein the at least one component fuse element of at least one component power branch comprises at least one electronic fuse and/or at least one fusible link.

21. The power distributor according to claim 16, wherein the at least one component fuse element of at least one component power branch comprises a plurality of series-connected component fuse elements.

22. The power distributor according to claim 16, wherein a current-carrying capacity of the at least one bypass current path is of at least equal magnitude to a maximum rated current of a largest load which is connected to the component power branches.

23. The power distributor according to claim 16, wherein exactly one bypass current path is provided.

24. The power distributor according to claim 16, wherein a plurality of bypass current paths are provided.

25. The power distributor according to claim 16, wherein the supply input connected to the component power branches corresponds to the supply input of the at least one bypass current path.

26. The power distributor according to claim 16, wherein the supply input connected to the component power branches is a supply input that differs from the supply input of the at least one bypass current path.

27. A power distribution system comprising:
the power distributor according to claim 16; and
a trip logic circuit configured to at least actuate the at least one electronic bypass fuse.

28. The power distribution system according to claim 27, wherein:
the at least one electronic fuse of the component power branches is configured to measure a voltage, a voltage differential, a current, and/or a temperature, and
the trip logic circuit is connected to the at least one electronic bypass fuse via a data connection, and is configured to receive corresponding measured values from the at least one electronic bypass fuse, and actuate the at least one electronic bypass fuse on a basis of measured values received.

29. A vehicle comprising:
the power distributor according to claim 16.

30. A method for operating a power distribution system,
wherein the power distribution system comprises:
a power distributor comprising:
a supply input electrically connected to a plurality of component outputs via respective component power branches, wherein each of the component power branches comprises at least one component fuse element; and
at least one bypass current path that is routed from a supply input to at least two of the component outputs, and which comprises at least one electronic bypass fuse a trip logic circuit configured to at least actuate the at least one electronic bypass fuse; and
a trip logic circuit configured to at least actuate the at least one electronic bypass fuse,
wherein the method comprises:
detecting a fault, a malfunction, and/or a tripping of at least one component fuse element; and
actuating, on a basis of the detecting, at least one electronic bypass fuse to switch to a conducting state.
